(19) United States
(12) Patent Application Publication
(10) Pub. No.: US 2004/0246827 A1
(43) Pub. Date: Dec. 9, 2004

(54) Optical disk device

(75) Inventors: Masanari Esaki, Ohmuta-shi (JP); Yuji Tanaka, Chikushino-shi (JP); Kazuo Matsumoto, Kikuchi-gun (JP); Noriyuki Ide, Tamana-shi (JP); Hirohisa Koizumi, Tamana-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/849,256

(22) Filed: May 20, 2004

(30) Foreign Application Priority Data
May 21, 2003 (JP) 2003-143029
May 27, 2003 (JP) 2003-148737
Jun. 23, 2003 (JP) 2003-177982
Jun. 25, 2003 (JP) 2003-180833

(51) Int. Cl. G11B 7/085

(52) U.S. Cl. 369/30.36

(57) ABSTRACT

According to the invention, case members each include a main surface and side surfaces provided at ends of the main surface. At a corner where a pair of side surfaces in at least one of the case members adjoin, an integral part having at least one pair of continuously integrated side surfaces is provided. Therefore, the corners of the case members can be prevented from bending or deforming, and the mechanical strength of the main surface can be improved. Therefore, the shock resistance can be improved, and the thickness of the case members can be reduced in order to reduce the size and weight of the device.

### BACKGROUND OF THE INVENTION

1. Field of the Invention

The present invention relates to an optical disk device provided preferably in an electronic device such as a personal computer, more preferably in a mobile electronic device.

A typical conventional optical disk device provided in a computer main body is entirely stored in a case and then provided in a space in the computer main body. The case has an attachment part that is attached to the computer main body for attaching the device.

FIG. 8 is a perspective view of a conventional optical disk device. FIG. 8 shows an optical pickup 1, a main shaft 2, a sub shaft 3, a spindle motor 4, a base 5, an optical pickup module (PUS) 6, a tray 7, a carriage 8, a rail 9, a case 10, an optical disk device 11, an attachment screw hole 12 on the optical disk device side, a circuit board 13 having a control device and the like thereon, and a frame 14.

FIG. 9 is a view showing how the conventional optical disk device is mounted to a mobile electronic device. FIG. 9 shows the mobile electronic device 15, an attachment 16 inserted for attachment, and an attachment hole 17 on the attachment side.

As described above, in the conventional disk device, the case 10 serves to position the tray 7 provided with the optical pickup module 6, the spindle motor 4 and the like thereon through the rail 9 and also fix an optical disk in the mobile electronic device 15. The structure has basically been unchanged even though the optical disk device has been reduced in thickness.

There has been an increasing demand for thinner and more lightweight optical disk devices in this conventional structure as there has been an increasing demand for thinner and more lightweight mobile electronic devices. The demand for more lightweight optical disk devices is particularly high but the above described structure makes it very difficult to reduce the weight.

### SUMMARY OF THE INVENTION

The invention is directed to a solution to the above described problems associated with the conventional technique, and it is an object of the invention to provide an optical disk device having reduced thickness and reduced weight in particular.

The optical disk device according to the invention includes a case having first and second case members fixed with each other, driving means for rotating a medium around, an optical pickup module including optical elements, and a circuit portion forming a control portion. At least one of the first and second case members is provided with a main surface and side surfaces provided at ends of the main surface. At a corner where at least a pair of side surfaces in at least one of the first and second case members adjoin, an integral part where the pair of side surfaces are continuously integrated is provided.

### BRIEF DESCRIPTION OF THE DRAWINGS

FIG. 1 is a perspective view of an optical disk device according to an embodiment of the invention;

FIG. 2 is a view showing how the optical disk device according to the embodiment is mounted to a mobile electronic device;

FIGS. 3 to 6 are partly expanded views of the optical disk device according to the embodiment;

FIGS. 7(a) to 7(c) are views showing the process of producing a case member for the optical disk device according to the embodiment;

FIG. 8 is a perspective view of a conventional optical disk device;

FIG. 9 is a view showing how the conventional disk device is mounted to a mobile electronic device;

FIG. 10 is a perspective view of a case member in the conventional optical disk device;

FIG. 11 is a partly expanded view of a case member in the conventional optical disk device;

FIGS. 12 and 13 are partly expanded views of an optical disk device according to an embodiment of the invention;

FIGS. 14 to 16 are perspective views of an optical disk device according to an embodiment of the invention;

FIGS. 17(a) to 17(c) are sectional views of the optical disk device according to the embodiment;

FIG. 18 is a perspective view of an optical disk device according to an embodiment;

FIG. 19 is a perspective view of the optical disk device according to the embodiment when viewed from the surface;

FIG. 20 is a perspective view of a lower cover according to the embodiment;

FIG. 21 is a view of a lower cover and a rail guide attached to the lower cover;

FIGS. 22(a) to 22(d) show protrusions and through holes;

FIGS. 23(a) and 23(b) and 24(a) to 24(c) show examples of an engagement part provided at the protrusion of the rail guide; and

FIGS. 25(a) and 25(b), FIGS. 26(a) to 26(c), and FIGS. 27(a) to 27(c) show examples of how the rail guide is fixed to the lower cover.

### DETAILED DESCRIPTION OF THE PREFERRED EMBODIMENTS

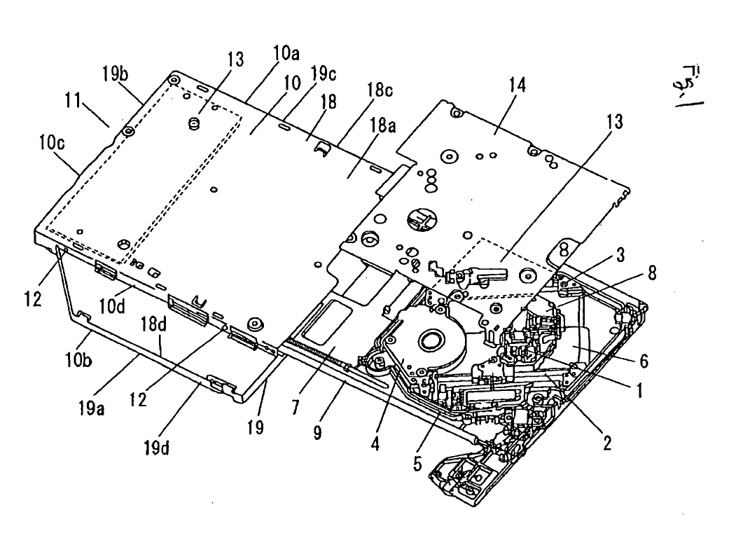

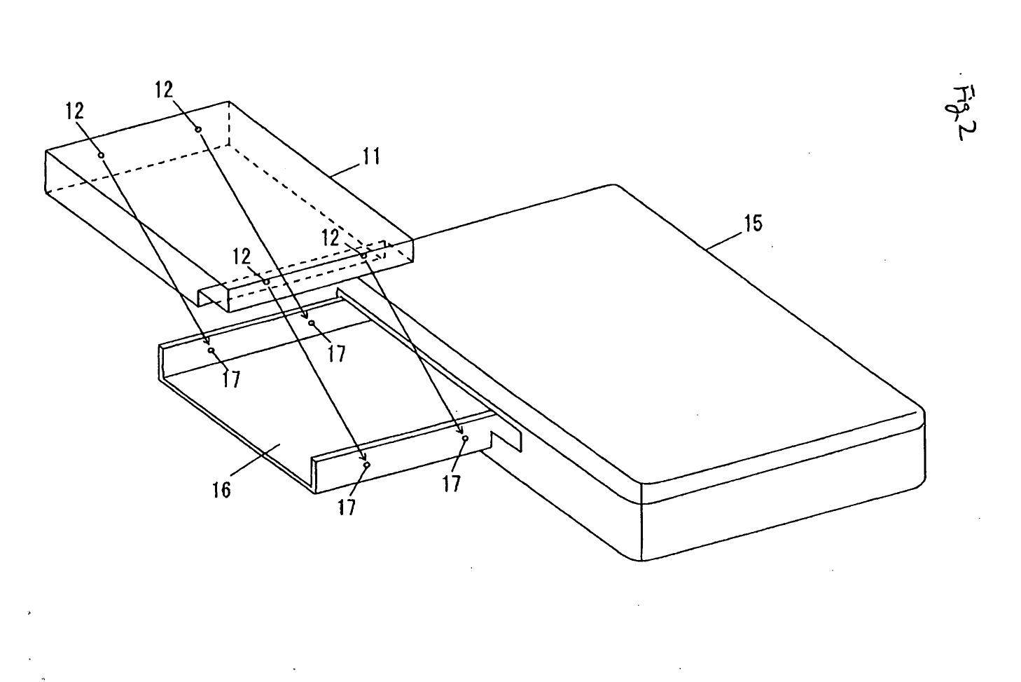

FIG. 1 is a perspective view of an optical disk device according to an embodiment of the invention, and FIG. 2 is a view showing how the device is mounted to a mobile electronic device. In FIG. 1, an optical pickup 1 reads/writes data from/to a disk mounted to a spindle motor as it moves in the radial direction of the spindle motor 4 using a main shaft 2 and a sub shaft 3 as a guide. The main shaft 2 and the sub shaft 3 are attached to a base 5 and form an optical pickup module 6 as a whole. The optical pickup module 6 is fixed to a tray 7. The tray 7 slides relative to the case 10 by the rail 9. The tray 7 is drawn out from the case 10 when an optical disk is mounted/dismounted and stored in the case 10 during data reading/writing. A circuit board 13 for forming a control circuit and the like thereon is attached to at least one of the tray and the case. In this way, the optical disk device 11 stored as a whole in the mobile electronic device is formed.

In FIG. 2, the case 10 for the main body of the optical disk device 11 has attachment screw holes 12 for attachment to the computer main body. The mobile electronic device 15 has an attachment 16 through which the device is mounted. Attachment holes 17 on the attachment side and the attachment screw holes 12 on the optical disk device side are engaged by screws and the attachment 16 is mounted to the mobile electronic device 15, so that the optical disk device is securely mounted.

The case 10 includes case members 18 and 19 fitted together and provided with rectangular main surfaces 18a and 19a and side surfaces 18b to 18d and 19b to 19d, respectively. The main surfaces 18a and 19a oppose the tray 7 and the side surfaces 18b to 18d and 19b to 19d are provided upright in the same direction at the periphery of the main surfaces. The side surfaces 18b and 19b are placed on each other to form the back surface 10c of the case 10 and the side surfaces 18c and 19c are placed on each other to form one side surface 10a of the case 10. The side surfaces 18d and 19d are placed on each other to form the other side surface 10b.

A metal plate is for example bent to integrally form the main surfaces and side surfaces of each of the case members 18 and 19. The case members 18 and 19 are each integrally made of a metal material such as iron, an iron alloy, aluminum, an aluminum alloy, and a magnesium alloy. Note that the case members 18 and 19 may have their surfaces plated with a metal film in order to improve their corrosion resistance.

The case member 18 is provided with the circuit board 13 for the circuit that controls at least one of recording and reproducing signal systems and a rail attachment portion (not shown) that movably holds the rail 9 is fixed to the case member 18.

The case members 18 and 19 are fitted together to form the case 10 so that an opening through which the tray 7 protrudes/withdraws is formed. At the time, the case members 18 and 19 are fitted together so that the side surfaces 19b to 19d of the case member 19 are positioned on the outer side than the side surfaces 18b to 18d of the case member 18. The side surface 10b provided with a step 10d is narrower than the other part, and therefore the side surface 18d is almost entirely covered by the side surface 19d with almost no part being exposed in FIG. 1. At the side surface 10a, the upper end of the side surface 18c is covered by the side surface 19c, and therefore the side surface 10a is made of the side surface surfaces 18c and 19c. Similarly at the back surface 10c, the upper end of the side surface 18b is covered by the side surface 19c, and the side surface 10a is made of the side surfaces 18c and 19c.

At least one of the case members 18 and 19 is reduced in thickness so that the weight of the optical disk device 11 is reduced.

When the case members 18 and 19 are fitted together and secured, they are firmly fixed with each other using fixing means such as screws.

According to the embodiment, at least one of the case members 18 and 19 is produced by drawing. More specifically, the case members 18 or/and 19 are formed by drawing rather than bending each side surface with respect to the main surface as conventionally practiced. In this way, the side surfaces adjacent at the corners of the case members 18 and 19 are provided with a part directly and integrally joined without through a slit (unconnected part). In the conventional case, slits (unconnected parts) provided at the parts where the side surfaces meet at the corners of the case members are likely to cause the side surfaces and the main surfaces to deform or bend. Meanwhile, according to the embodiment, at least one of the case members 18 and 19 is formed by drawing, and an integral part continuous to the side surfaces adjacent to each other is provided at each of the corners of the case members 18 and 19, so that the integral part securely fixes the side surfaces. Therefore, the mechanical strength of the side surfaces as well as the mechanical strength of the main surface connected to the side surfaces is considerably improved.

Now, the structure will be described in detail in conjunction with the accompanying drawings.

In the following, the case member 18 will be described by way of illustration.

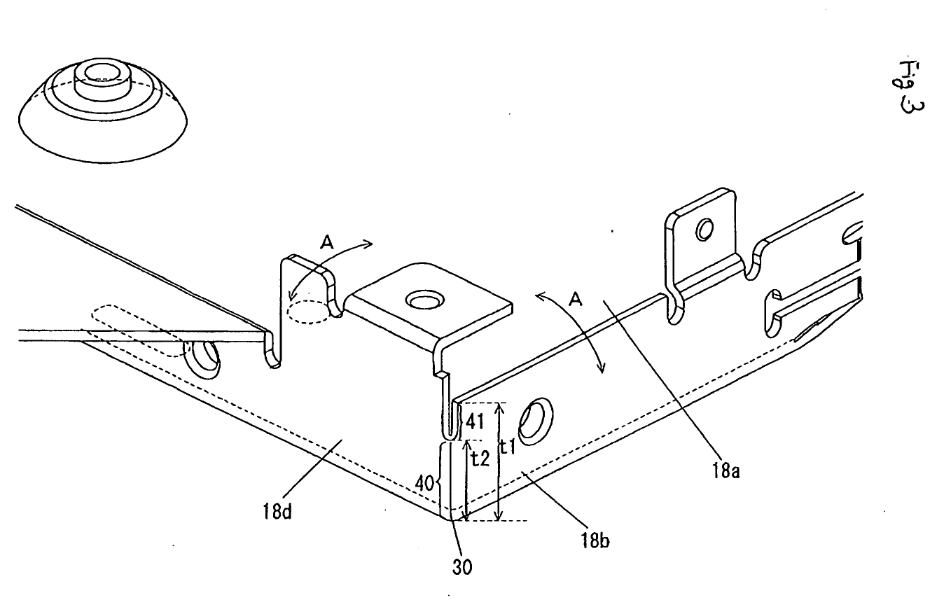

As shown in FIG. 3, at a corner 30, there is an integral part 40 where the side surfaces 18b and 18d are continuously provided. The corner 30 has the integral part 40 and a slit part 41 (unconnected part) in this order from the side of the main surface 18a. The integral part 40 can easily be formed by carrying out drawing to sheet metal. The integral part 40 integrates the side surfaces 18b and 18d, and the mechanical strength of the side surfaces. 18b and 18d considerably increases. More specifically, even with external force imposed upon the side surfaces 18b and 18d in the direction of arrow A in FIG. 3, the side surfaces 18b and 18d firmly united by the integral part 40 are unlikely to bend or deform. The main surface 18a is less likely to deform because the side surfaces 18b and 18d do not easily deform. The height t2 of the integral part 40 preferably satisfies the relation represented by t2/t1>0.2 when the height of the corner 30 is t1. If the integral part 40 is provided so that t2/t1>0.2, the mechanical strength of the side surfaces 18b and 18d may not be sufficiently reinforced by the integral part 40.

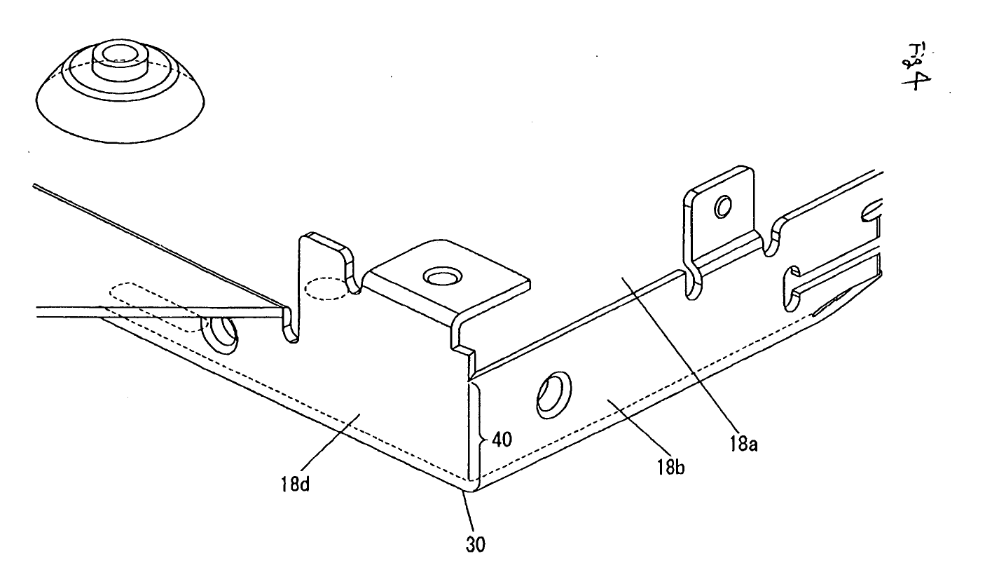

According to another embodiment, as shown in FIG. 4, the entire corner part 30 may be formed as the integral part 40. In this way, the mechanical strength of the side surfaces 18b and 18d can surely be increased, and the strength of the main surface 18a can be considerably increased.

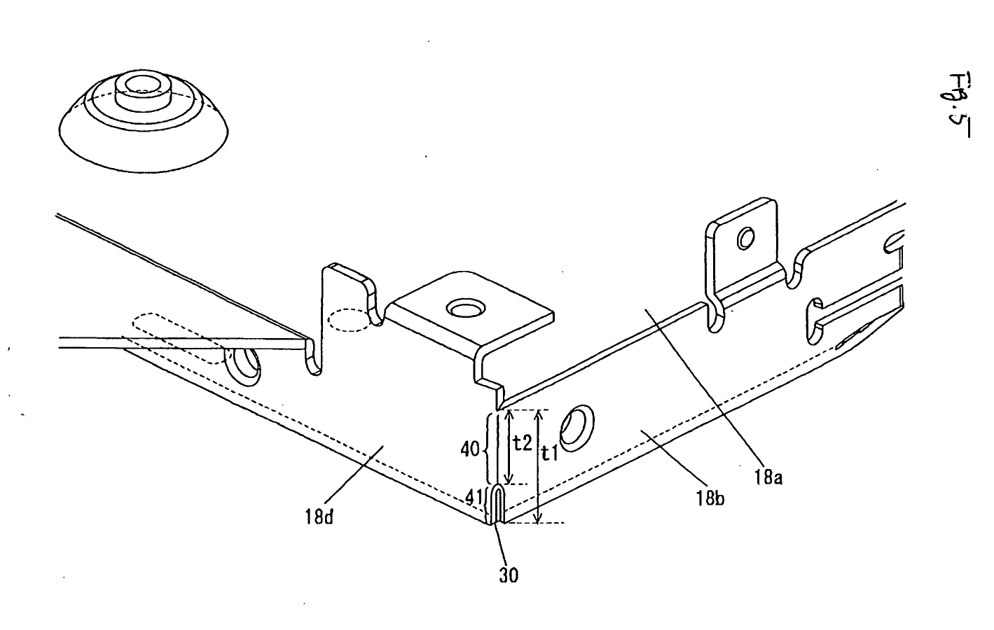

According to yet another embodiment, as shown in FIG. 5, the slit part 41 (unconnected part) and the integral part 40 may be provided in this order from the main surface 18a. As compared to the embodiment shown in FIG. 3, the integral part 40 is provided at the upper end of the side surfaces 18b and 18d, therefore the side surfaces 18b and 18d can be very strong against bending, and their mechanical strength extremely improves. Note that in this example, sufficient mechanical strength can be obtained when t2/t1>0.05.

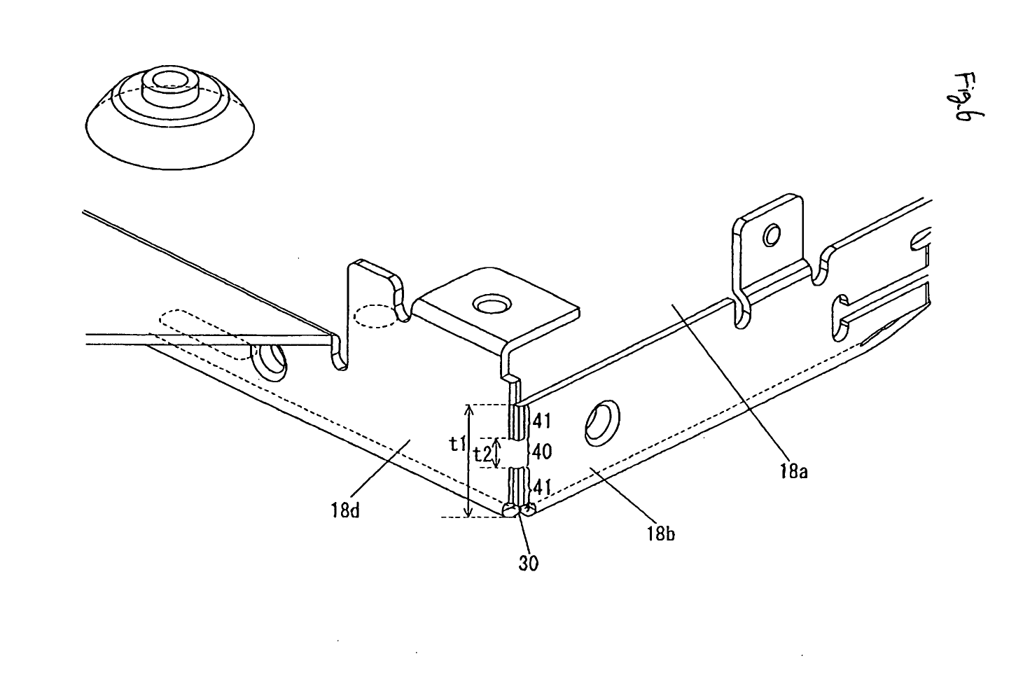

Finally, as shown in FIG. 6, the slit part 41 (unconnected part), the integral part 40, and a slit part 42 (unconnected part) may be provided in this order from the main surface 18a. In this example, sufficient mechanical strength can be obtained even when t2/t1>0.1.

The above described embodiments may be applied as desired depending on requirements and the like as shown in FIGS. 3 to 6.

According to the embodiments, the integral part 40 is provided at all the corners of the case member 18, while the integral part may be provided only at some of the corners. Alternatively, the case member 18 may be provided with no such integral part, while all or some of the corners of the case member 19 may be provided with the integral part 40. Most preferably, all the corners where the side surfaces of the case members 18 and 19 meet are each provided with the integral part 40, so that an optical disk device having extremely high mechanical strength can be provided.

The integral part 40 can easily be formed by drawing or deep drawing, and thus providing the integral part 40 allows the case members 18 and 19 to be reduced in thickness, so that the weight is reduced. When the case members 18 and 19 have reduced thickness in this way, the mechanical length of the case 10 itself can be extremely weak, which is not preferable, and therefore the integral part 40 is provided to prevent the side surfaces from bending and deforming even when at least one of the case members 18 and 19 is reduced in thickness for reducing the weight. In this way, the bending or deforming of the main surfaces 18a and 19a can be reduced. In other words, a lightweight optical disk device can be provided. Today, a thin optical disk device is often provided in a mobile product such as a notebook personal computer, and therefore the optical disk device must have high shock resistance. Therefore, if the case members 18 and 19 are not reduced in weight, the integral parts 40 provided at the corners of at least one of the case members 18 and 19 allows the mechanical strength and hence the shock resistance of the case 10 to be considerably improved.

The integral part 40 formed by drawing as described above can have a C shaped or relatively curved surface, and therefore when the optical disk device is inserted into an electronic device or the like, the rounded corners of the case 10 do not damage the other part of the electronic device by contacting or do not preclude the insertion into the electronic device by catching some part of the electronic device.

Now, a method of how the structure shown in FIG. 3 is produced by drawing will be described by way of illustration.

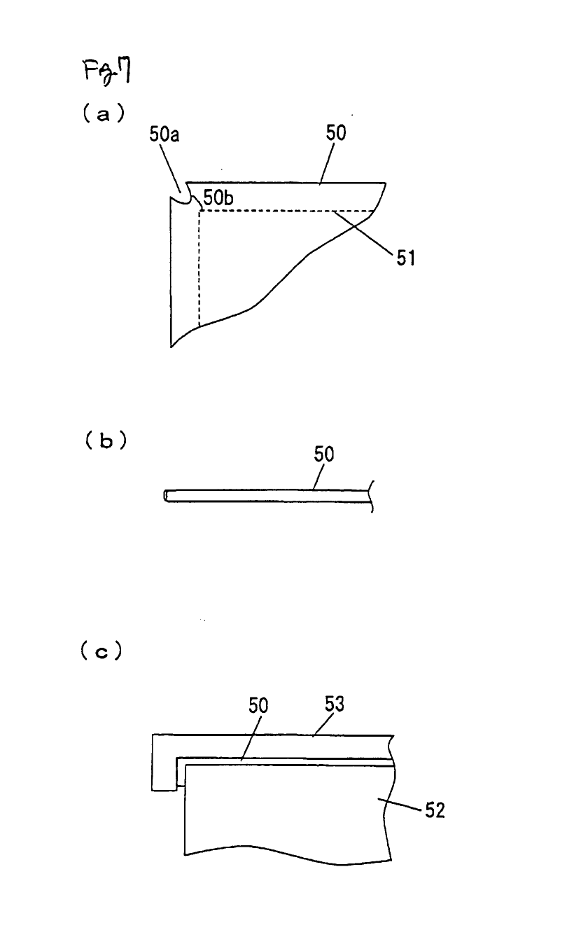

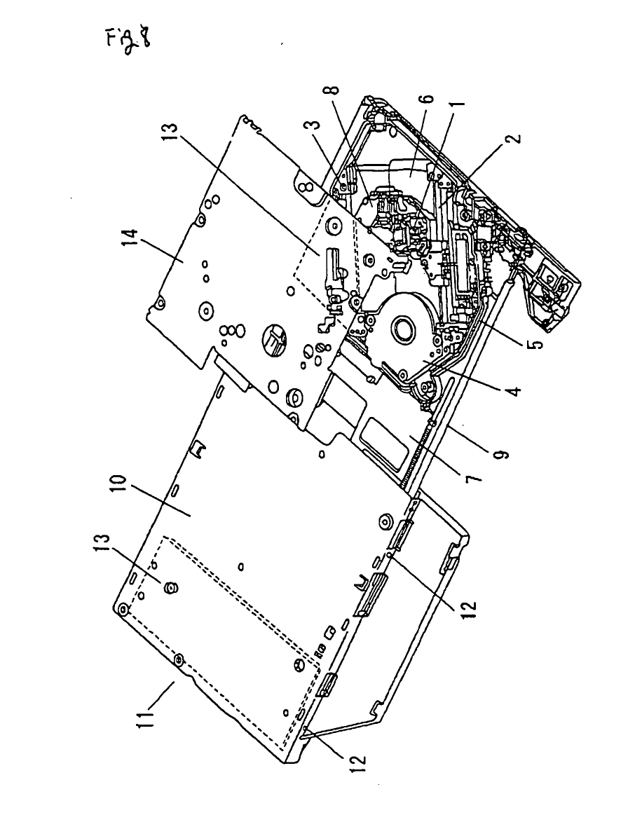

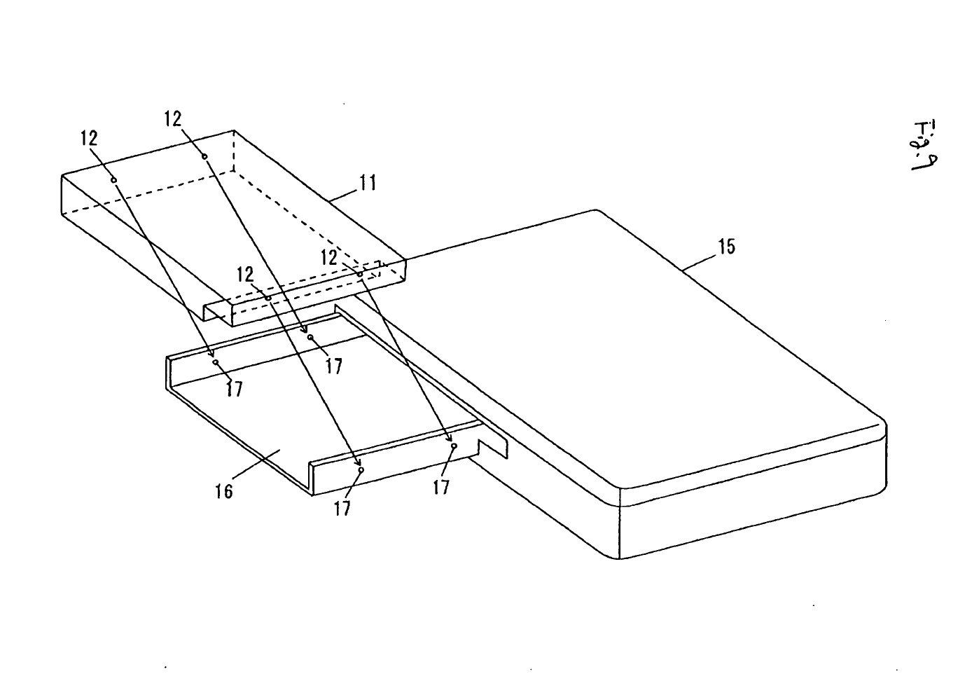

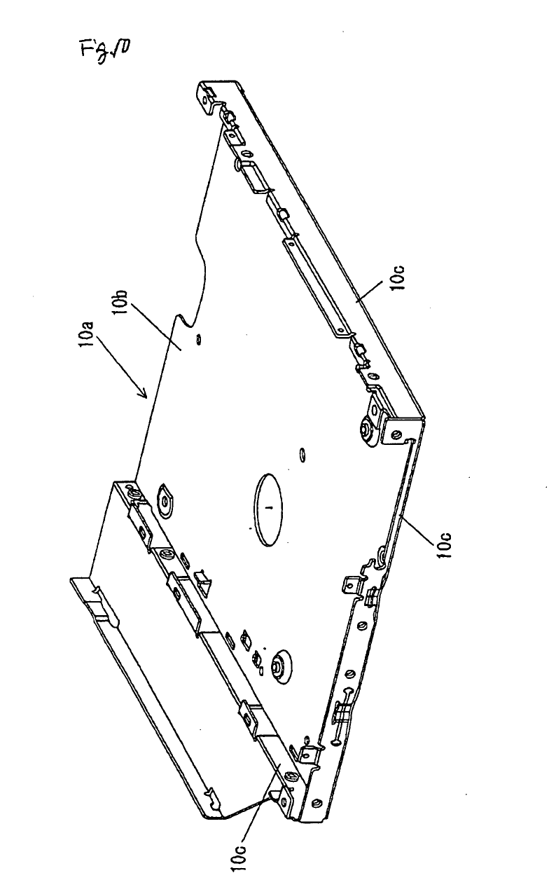

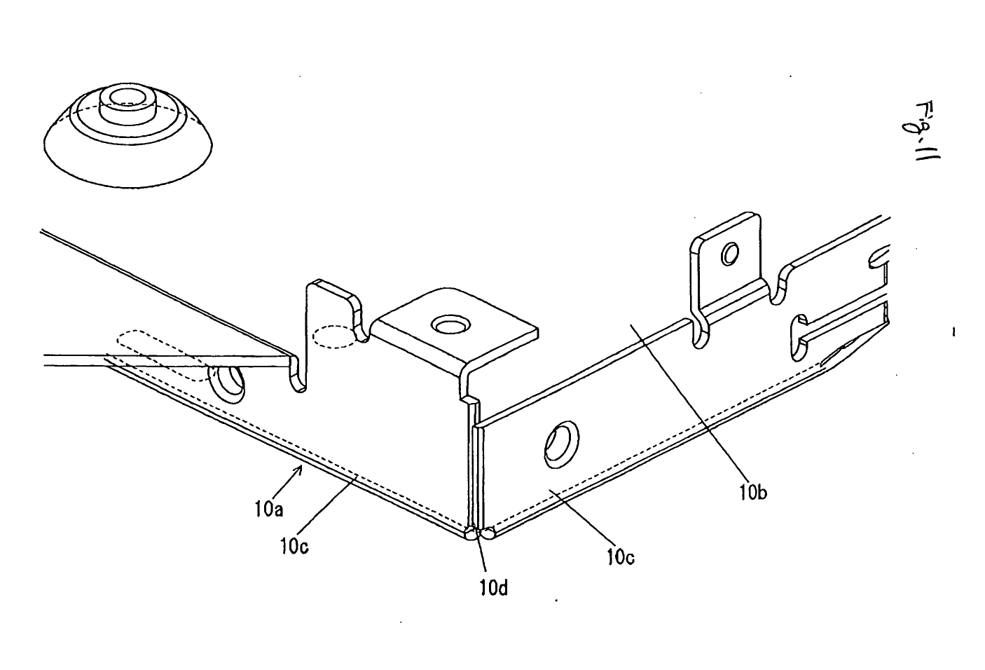

As shown in FIG. 7(a), a notch 50a is provided at a corner of a metal plate 50, and the part abutting against the outer periphery of a male die 52 is denoted by the dotted line 51. The notch 50a is formed into the slit 41 in FIG. 3, and the part 50b between the dotted line 51 and the notch 50a is formed into the integral part 40. FIG. 7(b) is a sectional view of the metal plate 50. As shown in FIG. 7(c), the metal plate 50 is inserted between the male die 52 and a female die 53 having a substantially L-shaped section, and then after the drawing, the rest of the part is bent or perforated, so that the case member 18 is formed. The case member 19 is produced in the same manner.

The case member 19 is thinner than that of the case member 18 so that the weight of the optical disk device 11 itself is reduced. As described above, the case member 18 holds the tray 7 and the like, and reducing the average thickness of the case 18 lowers the mechanical strength, which can cause troubles related to vibration or bending when the disk device is mounted to another electronic device. In other words, the device may not be able to perform as well as it is intended to.

Therefore, the average thickness of the case member 19 serving rather as a cover is reduced in order to reduce the weight of the optical disk device 11.

More specifically, the average thickness of the case member 18 may be large enough to keep the mechanical strength, while the thickness of the case member 19 can be reduced to reduce the weight as a whole. The average thickness of the case member 18 is from 0.4 mm to 0.9 mm. The average thickness of the case member 19 is from 0.3 mm to 0.58 mm. The thickness ranges of the case members 18 and 19 partly overlap, but basically the case member 18 is formed to have a larger thickness. The average thickness herein refers to the average of the thickness measured at 20 points randomly selected in the main surfaces 18a and 19a. If the average thickness of the case member 18 in the above described range is 1, the average thickness of the case member 19 is preferably from 0.4 to 0.83. If the value is less than 0.4, the mechanical strength of the case member 19 cannot be maintained, and if the value is more than 0.83, the gaps at the side surfaces of the case members 18 and 19 are small, and a protrusion 20 that will be described is of no use.

When the case members 18 and 19 are fitted together and fixed, fixing means such as screws is used to firmly unite them.

Now, the protrusion 20 will be described in detail.

The protrusions 20 are provided at the parts of the side surfaces 19b to 19d of the case member 19 that oppose the side surfaces 18b to 18d of the case member 18. Note that according to the embodiment, two protrusions 20 are provided only at the side surface 19b corresponding to the back surface 10c, but one protrusion or three or more protrusions may be provided. One or more protrusions 20 may be provided at at least one side surface selected among the side surfaces 19b to 19d.

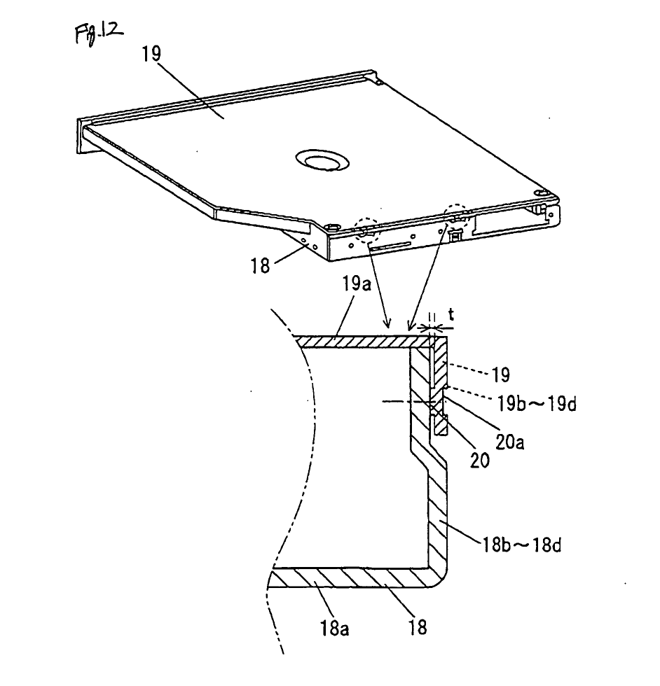

The protrusion 20 is provided integrally with the side surfaces 19b to 19d, and as can be seen from FIG. 12, the protrusion 20 is formed by extrusion process. More specifically, a recess 20a is provided at the part of the side surfaces 19b to 19d on the opposite side to the protrusion 20. The protrusion 20 is columnar according to the embodiment, but the shape may be a triangular, quadratic, or pentagonal prism or a hemisphere. Note that according to the embodiment, the protrusion 20 is integrally provided at at least one of the side surfaces 19b to 19d, while the protrusions 20 of a different material may be formed at the side surfaces 19b to 19d. For example, solder or silver brazing metal may be applied in a dotted pattern to form protrusions. The protruding height t of the protrusion 20 is preferably substantially equal to the difference between the average thickness of the case member 18 and that of the case member 19. When for example the average thickness of the case member 18 is 0.7 mm and the average thickness of the case member 19 is 0.5 mm, the protruding height t of the protrusion 20 is preferably 0.2±0.05 mm (most preferably 0.2 mm).

As in the foregoing, in the process of making the average thickness of the case member 19 smaller than that of the case member 18, the protrusion 20 eliminates the necessity of changing the bending size or position in forming the case member 19 every time the case member 19 is thinned. In addition, the case member 19 does not have to be re-designed every time the case member 19 is thinned, which improves the productivity.

More specifically, when a case member 19 having an average thickness of 0.5 mm and a case member 19 having an average thickness of 0.4 mm are mounted to the case member 18 having a thickness of 0.7 mm, a gap is created between the side surfaces of the case members if there are not the protrusions 20. Then, the case members 18 and 19 are not fitted together well. In order to fill the gap, the bending position or the like must be changed depending on the average thickness as described above. According to the embodiment, simply by producing the protrusions 20 to have a prescribed height (preferably substantially equal to the average thickness of the case members 18 and 19), the top of the protrusions 20 abuts against the inner side surfaces of the side surfaces 18b to 18d of the case member 18, so that the case members 18 and 19 are fitted together less shakily despite the gap created between them. In this way, the case members 18 and 19 may be fixed with each other for example by screws without any troubles, which improves the productivity and the design of the case member 19 can easily be changed.

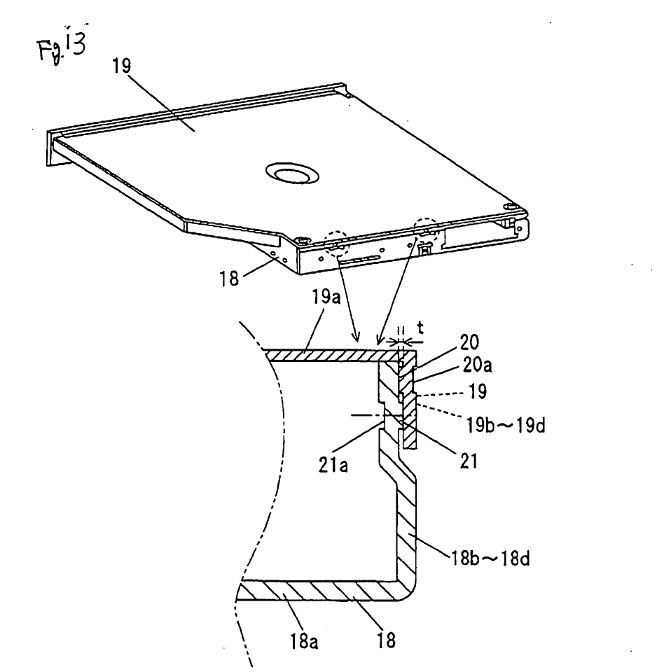

As shown in FIG. 13, not only the case member 19 is provided with the protrusion 20, but also the case member 18 is provided with a protrusion 21 similar to the protrusion 20, in other words, the case members 18 and 19 are provided with the protrusions 21 and 20, respectively, so that even more significant effects may result.

At the time, the protrusions 20 and 21 are preferably provided shifted from one another as shown in FIG. 13 so that the protrusions 20 and 21 do not abut against each other. According to the embodiment, they are aligned in the thickness-wise direction of the case 10 while the protrusions 20 and 21 may be provided alternately in the width-wise direction perpendicular to the thickness-wise direction of the case 10. According to the embodiment, both the protrusions 20 and 21 are provided at one side surface of the case 10. Meanwhile, only the protrusion 20 may be provided at a particular side surface of the case 10, and the protrusion 21 may be provided at the other side surfaces. Alternatively, the protrusions 20 and 21 may be provided at a first side surface of the case 10, only the protrusion 20 may be provided at a second side surface of the case 10, and only the protrusion 21 may be provided a third side surface of the case 10.

The protrusions 20 and 21 have the same height t according to the embodiment, while one of the protrusions 20 and 21 may be higher than the other or the protrusions 20 and 21 may have various heights among themselves depending on the requirements of the case members 18 and 19.

In this way, at least either by drawing the case members 18 and 19 or providing at least the protrusion 21 to the case member 18, the case 10 can have reduced weight.

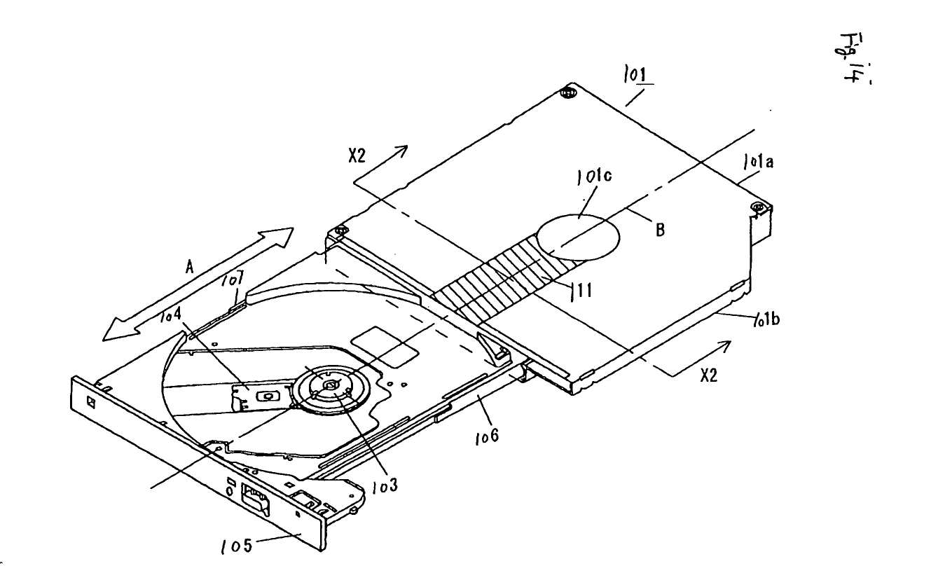

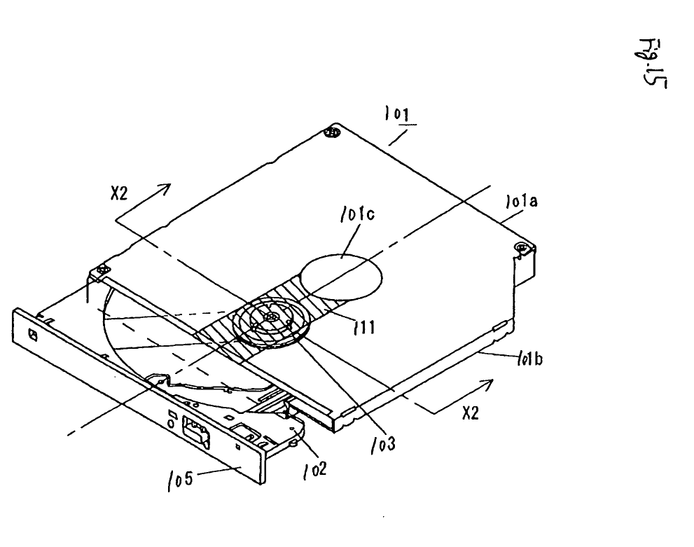

Now, other ways of reducing the weight will be described in conjunction with FIGS. 14 to 17.

A case 101 includes an upper case member 101a and a lowercase member 101b fitted together. The upper and lower case members 101a and 101b are fixed with each other by screws or the like. The case 101 may be made of a metal material such as iron, an iron alloy, aluminum, an aluminum alloy, and a magnesium alloy or a resin material. The upper case members 101a and 101b may be made of materials of the same kind or different kinds. The average thickness of the main plane parts of the upper and lower case members 101a and 101b is from 0.3 mm to 1.6 mm. When the average thickness is relatively small, the upper and lower case members 101a and 101b are made of a metal material and produced for example by press-working a metal plate. When the average thickness is relatively large, the upper and lower case members 101a and 101b are made of a resin material or a die cast material (such as aluminum and a magnesium alloy). When the case 101 is made of a resin material, the optical disk device can have reduced weight.

A tray 102 provided at the case can protrude/withdraw from/into the case. The tray 102 is made of a resin frame and has parts that will be described. A spindle motor 103 is provided at the tray 102. An optical pickup 104 includes at least an optical source and optical elements that are not shown and writes/reads information to/from an optical disk by irradiating the optical disk with light. A bezel 105 provided at the front end of the tray 102 closes the opening through which the tray 102 protrudes/withdraws when the tray 102 is stored in the case 101. The bezel 105 is made of a resin material or a metal material. Rails 106 and 107 are slidably provided at the tray 102 and the case 101, respectively. The rails 106 and 107 are provided along the sides of the tray 102 and the tray 102 is attached to the case 101 in such a manner that the tray 102 can protrude/withdraw from/into the case 101 in the directions denoted by arrow A in FIG. 14. In the upper case member 101a, a through hole 101c is provided at the part opposing the spindle motor 103 when the tray 102 is stored in the case 101.

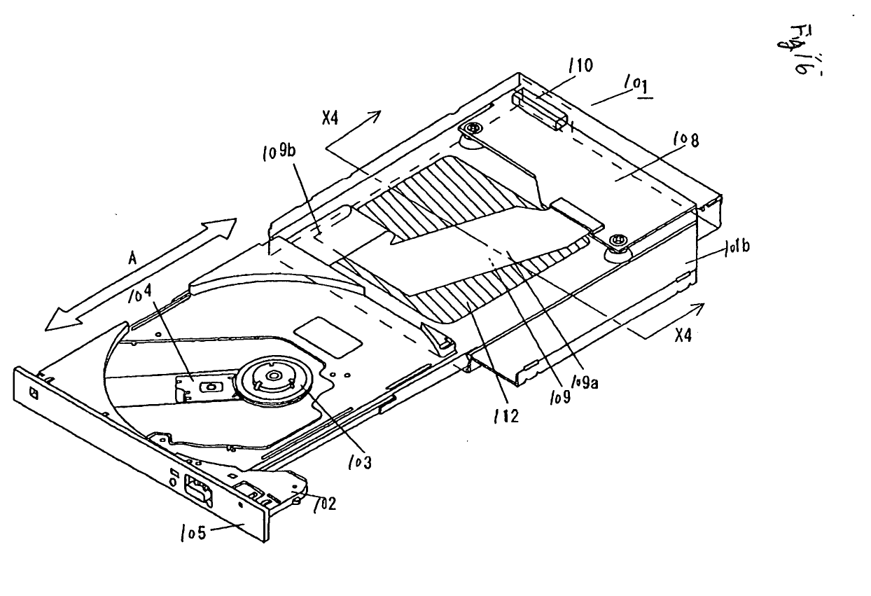

In FIG. 16, a circuit board 108 is fixed in the back of the case 101 and has an IC for signal processing, a power supply circuit and the like thereon. A flexible printed circuit board 109 electrically connects a circuit board (not shown) provided at the tray 102 and the circuit board 108 and is formed to have an approximately U shape. The printed circuit board 109 includes a fixed part 109a attached to the inner wall of the case 101 and a movable part 109b integrally connected to the fixed part 109a. The fixed part 109a has an end connected to a connector 108a and the movable part 109b has an end electrically connected to a connector (not shown) provided on the circuit board on the tray 102. The movable part 109b is not fixed to the lower case member 101b and therefore bent and connected to the tray 102, which prevents the printed circuit board 109 from being caught somewhere in the case 101 when the tray 102 protrudes/withdraws from/into the case 101. Note that the fixed part 109a is fixed to the lower case member 101b by a double-faced adhesive tape or by an adhesive. The printed circuit board 109 may be placed and fixed between a length of single-faced adhesive tape and the lower case member 101b.

An external connector 110 is connected to a power supply/signal line provided at an electronic device such as a computer. Through the external connector 110, electric power is supplied into the optical disk device, externally applied signals are transferred into the optical disk device, or electrical signals generated by the optical disk device are transmitted to an electronic device.

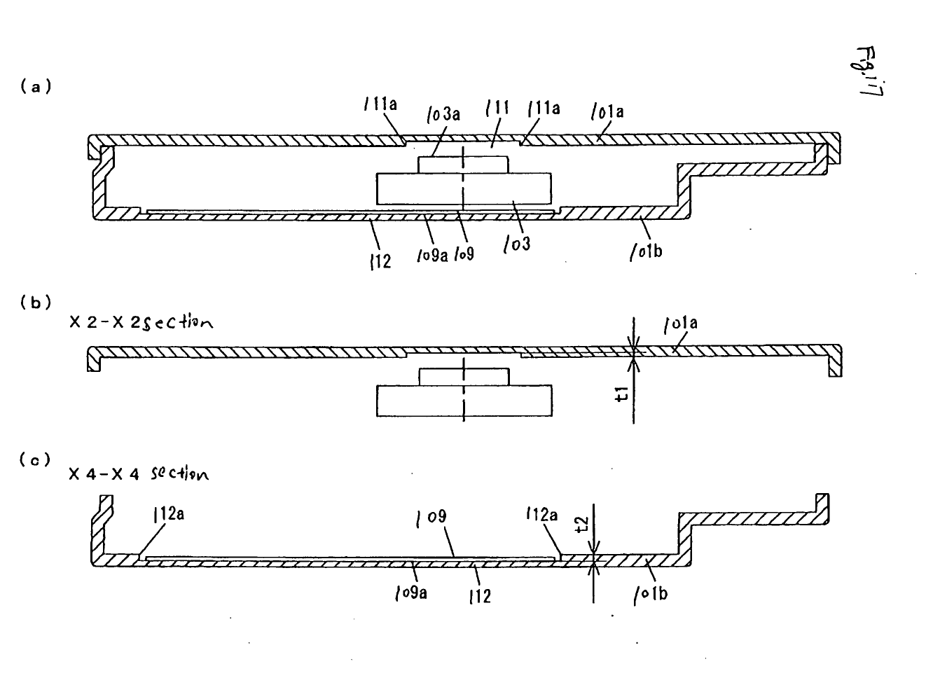

In FIGS. 14, 15, and 17(a), a recess 111 is provided in a position where the spindle motor 103 can oppose the inner wall of the upper case 101a. In this way, by the presence of the recess 111, the upper surface 103a of the spindle motor 103 is less likely to contact the upper case member 101a if the gap between the upper and lower case members 101a and 101b is narrowed. Note that the depth t1 of the recess 111 (see FIG. 17(b)) is preferably from 0.1 mm to 0.6 mm. Note that according to the embodiment, the average thickness of the upper and lower case members 101a and 101b is from 0.3 mm to 1.6 mm, and therefore the depth t1 of the recess 111 should be set as required in consideration of the average thickness. If the depth t1 is smaller than 0.1 mm, the recess 111 is of no use, and the gap between the upper and lower case members 101a and 101b cannot be narrowed enough. Meanwhile, when the depth t1 is larger than 0.6 mm, the upper and lower case members 101a and 101b must have larger thickness. Therefore, the depth t1 is preferably from 0.1 mm to 0.6 mm as described above.

According to the embodiment, the recess 111 is provided in a string shape that extends from the opening to the through hole 101c at the inner wall of the upper case member 101a, but the recess may have a width equal to or larger than the width of the upper surface 103a. The recess may be in various shapes other than the string shape. The recess 111 is provided at a part of the inner wall of the upper case member 101a, so that the device may be thinned while the mechanical strength of the upper case member 101a is maintained. Note that the upper case member 101a is made of a metal material such as a metal plate, and the material can be processed by cutting, etching, drawing or the like. Meanwhile, when the upper case member 101a is made of a resin material or a die cast material (such as aluminum and an magnesium alloy), the material may readily be processed by cutting, resin molding, die casting and the like.

Note that according to the embodiment, the corners 111a of the recess 111 substantially form a right angle, but the sharp angled corners 111a can easily damage members inside when large impact is applied upon the optical disk device, and therefore the corners 111a are preferably tapered or chamfered.

According to the embodiment, the depth t1 of the recess 111 is approximately the same in any locations, but the depth t1 may be reduced or increased toward the through hole 110c or the depth may be reduced or increased in a stepped manner toward the through hole 101c. As shown in FIG. 14, the depth t1 of the recess 111 may be larger in the part on the central line B and may be reduced smoothly or in a stepped manner in the width-wise direction perpendicular to the central line B.

In FIGS. 14, 16, and 17(a), a recess 112 is provided at the inner wall of the lower case member 101b opposing the fixed part 109a. In this way, the gap between the upper and lower case members 101a and 101b in the case 101 can be reduced by the thickness of the printed circuit board 109 (that would not be reduced otherwise) by providing the recess 112 and the fixed part 109a in the recess 112 as described above. Therefore, the device can be thinned accordingly. Note that the depth t2 of the recess 112 (see FIG. 17(c)) is preferably from 0.1 mm to 0.6 mm. Note that according to the embodiment, the average thickness of the upper and lower case members 101a and 101b is from 0.3 mm to 1.6 mm, and therefore the depth t2 of the recess 112 should be set as required in consideration of the average thickness. If the depth t2 is smaller than 0.1 mm, the recess 112 is of no use, and the gap between the upper and lower case members 101a and 101b cannot be narrowed enough. Meanwhile, if the depth t2 is larger than 0.6 mm, the upper and lower case members 101a and 101b must have larger thickness. Therefore, the depth t2 is preferably from 0.1 mm to 0.6 mm as described above. As shown in FIG. 16, the recess 112 (having a rectangular outer shape according to the embodiment) having a greater area than the area of the attached fixed part 109a allows the operation of attaching the fixed part 109a to be easily carried out, which improves the productivity. Note that if the operability may be ignored, the recess 112 may be provided only at the adhesion part of the fixed part 109a, so that the fixed part 109a may be stored in the recess 112 and still the device can be sufficiently thinned. It is understood that the depth t2 of the recess 112 is preferably equal to or larger than the thickness of the printed circuit board 109 plus the thickness of the double-faced tape or adhesive used for attaching the printed circuit board 9. Meanwhile, if the thickness t2 is slightly smaller than the thickness of the printed circuit board 109 plus the double-faced tape or the like and the upper part of the printed circuit board 109 protrudes from the recess 112, the device can still be thinned by the amount of the provided recess 112.

In the process of providing the fixed part 109a of the printed circuit board 109 in the recess 112 and allowing the bent part of the movable part 109b to slide onto the recess 112, the fixed part is positioned almost on the recess 112, so that the bending degree of the bent part of the movable part 109b is somewhat alleviated. Therefore, the printed circuit board 109 can be prevented from being bent sharply and having line disconnection.

According to the embodiment, the recess 112 has a rectangular outer shape or a shape substantially the same as that of the fixed part 109a of the printed circuit board 109, while the fixed part 109a needs only have a storable shape. When the recess 112 is provided at part of the inner wall of the lower case member 101b, the device can be thinned while the mechanical strength of the lower case member 101b is maintained. Note that when the lower case member 101b is made of a metal material such as a metal plate, the material may be processed by cutting, etching, drawing and the like. When the upper case member 101b is made of a resin material or a die cast material, the material may readily be processed by cutting, resin molding, die casting and the like.

Note that according to the embodiment, the corners 112a of the recess 112 substantially form a right angle, but the sharp angled corners 112a can easily damage members inside when large impact is applied upon the optical disk device, and therefore the corners 112a are preferably tapered or chamfered.

According to the embodiment, the depth t2 of the recess 112 is approximately the same in any locations, but the depth t2 may be reduced or increased from the center of the recess 112 to the ends or the depth may be reduced or increased in a stepped manner from the center of the recess 112 to the ends.

At least one of the recesses 111 and 112 is provided, and the optical disk device can be thinned. The depths t1 and t2 of the recesses 111 and 112 are approximately the same, but they may be different depending on the requirements of the device and the parts.

Note that according to the embodiment, a flexible printed circuit board that can be suitably thinned and easily handled is used as line connection means, but something deformable such as a flat cable and a lead can be used.

In this way, at least either the line connection means whose thickness would otherwise impede the thinning of the device is stored in the recess provided in the case or the recess is provided excluding the top surface of the driving means. Therefore, the gap between the case members can be narrowed without reducing the thickness of the case, and the device can be thinned. Even without narrowing the gap between the case members, the bending degree of the bent part of line connection means such as the flexible printed circuit board is less sharp by providing the line connection means in the recess and therefore the line connection means can be prevented from being disconnected.

In this way, at least the case members 18 or/and 19 are subjected to drawing or the case member 18 is provided with at least the protrusion 21 in the optical disk device described above and in addition at least one of the recesses 111 and 112 is provided at each of the case members, so that both the thickness and weight can be reduced.

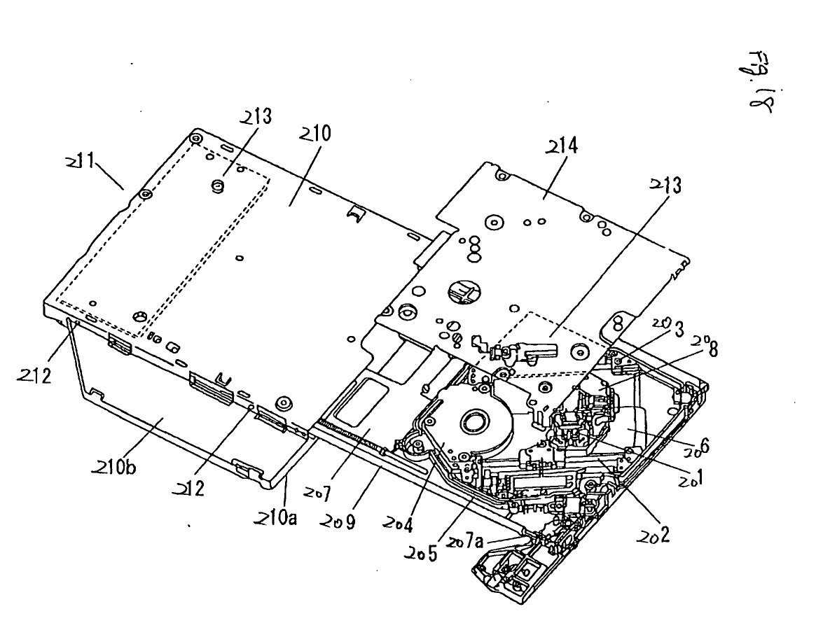

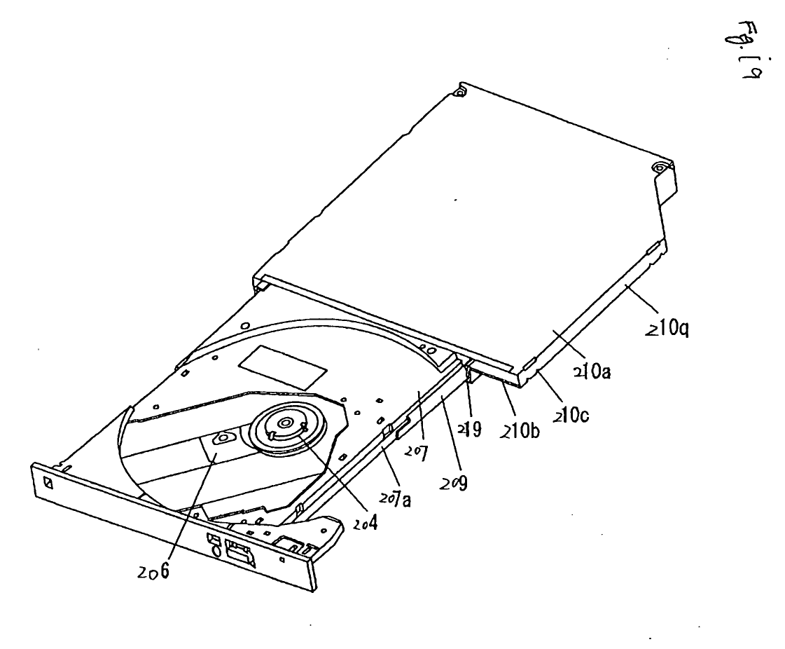

Another way of reducing the weight will be described in conjunction with FIGS. 18 to 27(c). When the weight is reduced, the strength of the parts of the case may be reduced. The following embodiment is directed to a solution to such a problem. The figures show an optical pickup 201, a main shaft 202, a sub shaft 203, a spindle motor 204, a base 205, a pickup module (PUM) 206, a tray 207, a carriage 208, a rail 209, a case 210, an optical disk device 211, an attachment screw hole 212 on the optical disk device side, a circuit board 213 having a control circuit and the like thereon, and a frame 214. The pickup module 206 and the tray 207 oppose a bottom surface 210h.

The case 210 includes an upper cover 210a and a lower cover 210b. The case 210 is made of a material strong enough to hold the elements of the optical disk device 211 and to be fixed to an electronic device. The material is preferably a metal material such as iron, an iron alloy, aluminum, an aluminum alloy, and a magnesium ally, particularly preferably a lightweight metal material such as aluminum and an aluminum alloy. The surface of the material may be plated with a metal film in order to improve its corrosion resistance. The case 210 may be a resin material that can maintain strength despite its small thickness.

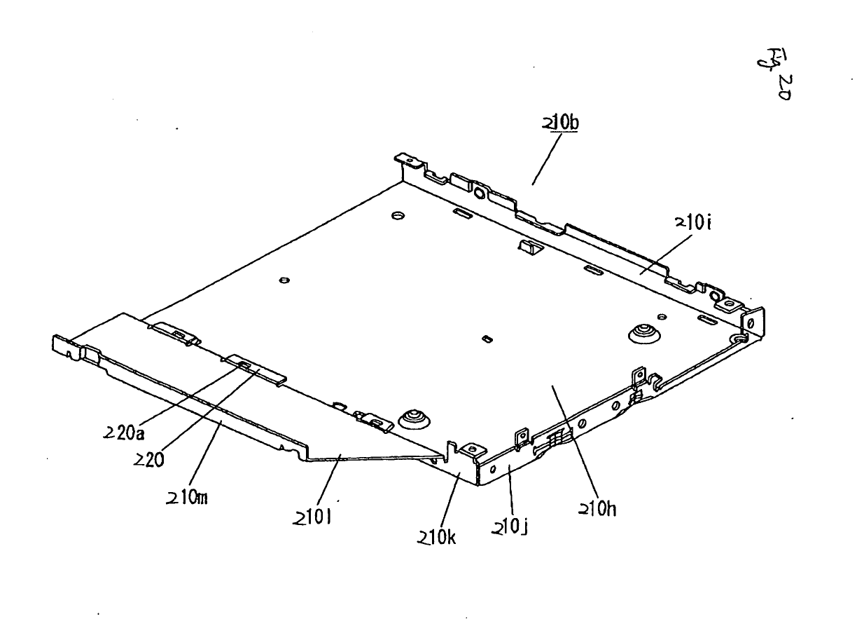

The upper cover 210a is a flat plate shape and has a side surface 210q approximately perpendicular to an end. In FIG. 20, in the lower cover 210b, side surfaces 210i, 210j, and 210k approximately perpendicular to the bottom surface 210h are provided at the three sides excluding the side for drawing out the tray among the four sides of the regular square or rectangular bottom surface. Among the three side surfaces approximately perpendicular to the bottom surface 210h, the distance between the two sides 210i and 210k parallel to the direction in which the tray 7 is drawn out is smaller than the diameter of a maximum size disk to be mounted. Therefore, the end of the side surface 210k is substantially parallel to the bottom surface 210h and is bent with respect to the side surface 210k in the direction opposite to the bottom surface 210h in order to avoid interference with the disk and thus forms a sub bottom surface 210l. At the end of the sub bottom surface 210l, a side surface 210m is formed substantially parallel to the side surface 210i and on the opposite side to the side surface 210k with respect to the sub surface 210l at such a distance not to interfere with a disk having the maximum diameter. The upper and lower covers 210a and 210b are engaged with each other in several locations between the side surface 210q of the upper cover 210a and the side surfaces 210i, 210j, 210k, and 210m of the lower cover 210b.

A flat plate shaped protrusion 220 substantially parallel to the bottom surface 210h is formed from the side surface 210k toward the bottom surface 210h. The structure described above is preferably made from a sheet of plate metal by processing including bending for the ease of processing. The protrusion 220 may be formed so that the shape of the protrusion 220 is cut in the side surface 220, and the root of the protrusion 220 is not bent when the sub bottom surface 210l is bent.

Rail guides 219 and 219g are provided in contact with the side surfaces 210i and 210k on the side of the bottom surface 210h. A rail 209 is movably held at the rail guides 219 and 219g, and a tray 207 is held movably at the rail 209 by a rail holding portion 207a.

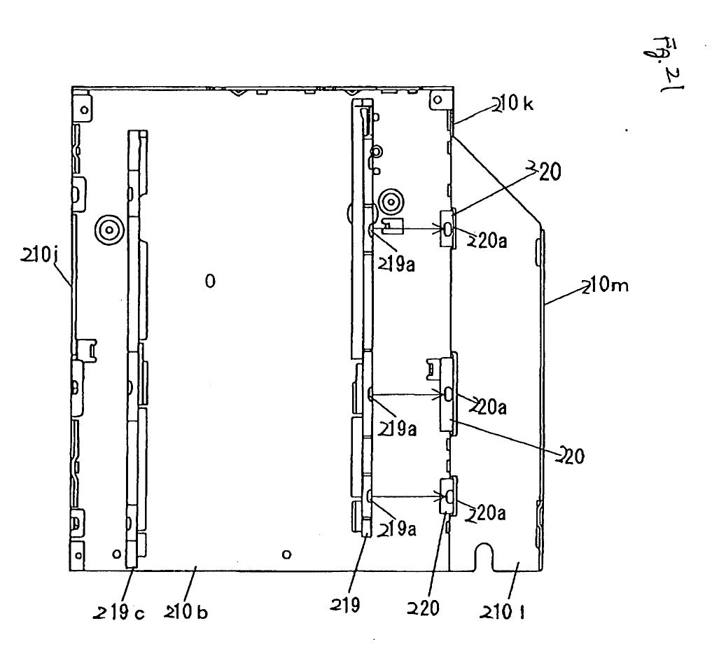

Now, the structure of the lower cover 210b, and the rail guides 219 and 219g will be described in detail in conjunction with FIG. 21.

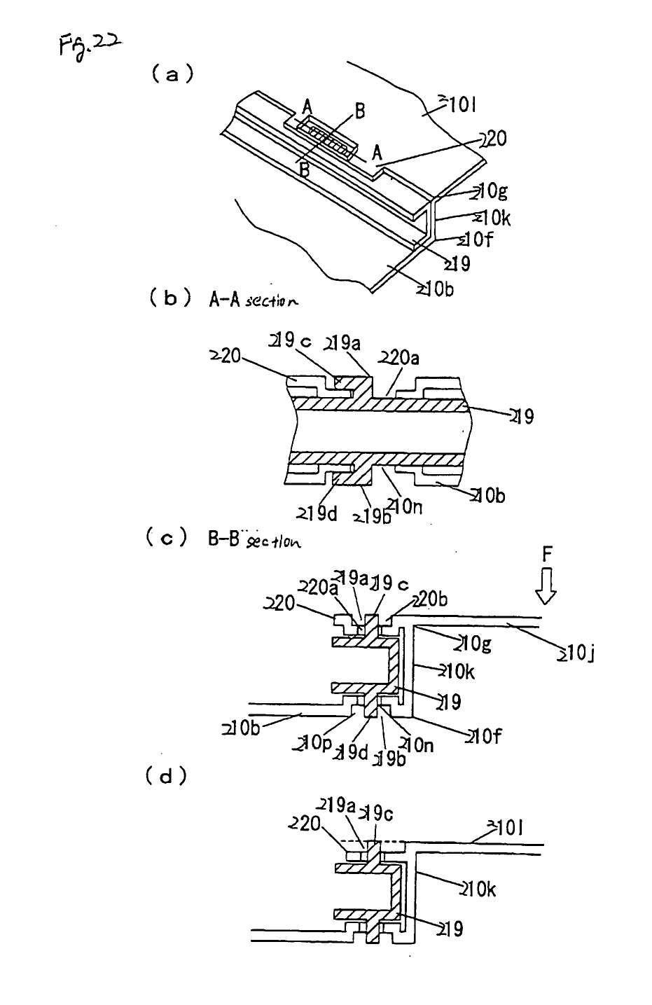

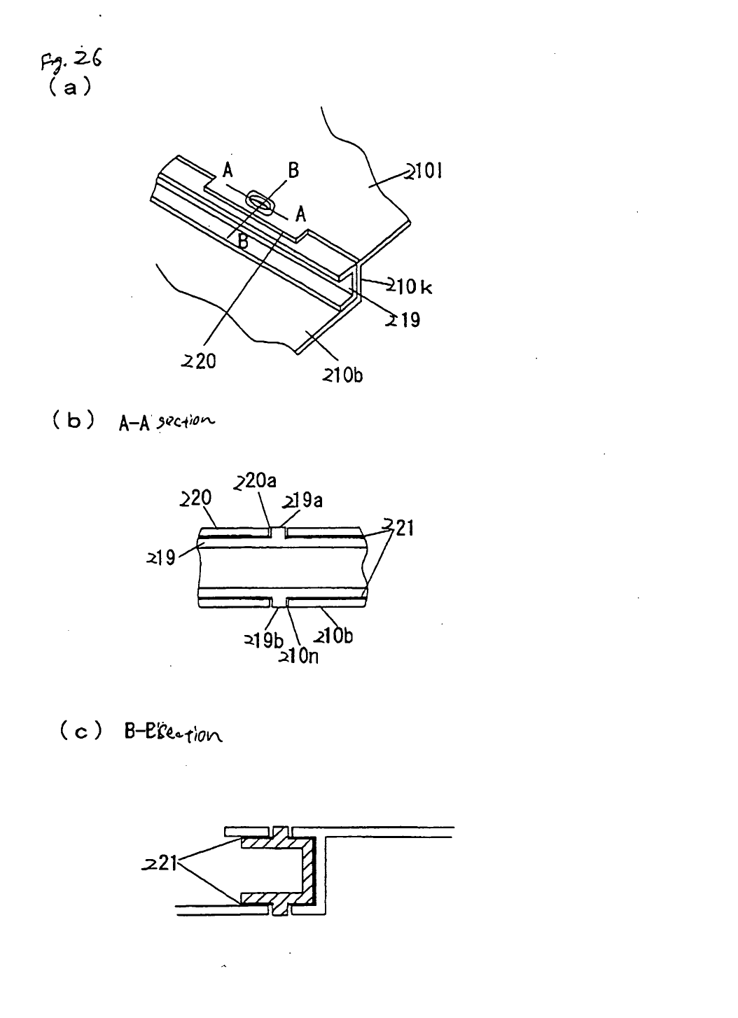

FIG. 21 shows the lower cover 10b and the rail guide attached to the lower cover 10b. FIGS. 22(a) to 22(d) show the protrusion 219a and a through hole 220a. There are the rail guide 219 mounted in contact with the side surface 210k and the rail guide 219g mounted in contact with the side surface 210i. How the rail guide 219g is formed and attached may be the same as the conventional rail guide. The rail guide 219 is between the protrusion 220 and the bottom surface 210h, and the through hole 220a is provided in an overlapping position between the rail guide 219 and the protrusion 220 on the side of the protrusion 220. A through hole 210n is provided in an overlapping position between the rail guide 219 and the bottom surface 210h on the side of the bottom surface 210h. The rail guide 219 is provided with a protrusion 219a inserted into the through hole 220a of the protrusion 220 and a protrusion 219b inserted into the protrusion 210n of the bottom surface 219h. As the protrusions 219a and 219b are inserted to the through holes 220a and 210n, the rail guide 219 is mounted to the lower cover 210b. The protrusions 219a and 219b have engagement parts 219c and 219d, respectively. After the protrusions 219a and 219b are inserted to the through holes 220a and 210n, the rail guide 219 is allowed to slide and engage with the protrusion 220 and the bottom surface 210h. In this way, the rail guide 219 is engaged by the engagement parts 219c and 219d and reinforces the bent parts 210f and 210g, so that the deformation of the bent parts 210f and 210g caused for example by load F as shown in FIGS. 22(c) and 26(b) imposed on the vicinity of the bent parts 210f and 210g can be reduced.

Note that as shown in FIGS. 22(a) to 22(d), in the vicinity of the through hole 220a of the protrusion 220 and the through hole 210n of the bottom surface 210h, recesses 220b and 210p can be provided so that the top of the engagement parts 219c and 219d of the rail guide 219 do not protrude from the surface of the protrusion 220 and the bottom surface 210h. Alternatively, the protrusion 220 may be provided with a step approximately aligned with the intersecting line between the protrusion 220 and the side surface 210, so that the top of the engagement part 219c does not protrude from the sub surface 210l as shown in the B-B section in FIG. 22(c).

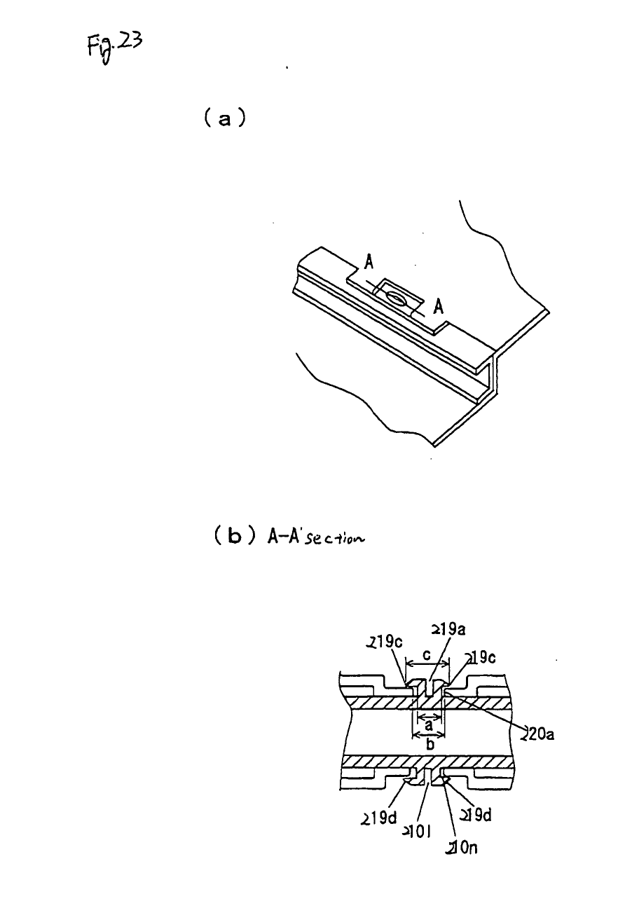

FIGS. 23(a) to 27(c) show other examples of the engagement parts provided at the protrusions 219a and 219b of the rail guide 219. The protrusions each include two or more protrusions and have their ends bent in the opposite directions from each other to form the engagement parts 219c and 219d. The outer size a of the protrusion is equal to or smaller by allowance for engaging than the size b for which the through holes 220a and 210n oppose. The outer size c of the engagement parts 219c and 219d is larger than the corresponding size b of the through holes 220a and 220n but is set so that the protrusions 219a and 219b and the engagement parts 219c and 219d can be press-fitted into the through holes 220a and 210n. The shape of the engagement parts on the side to be engaged with the lower cover 210b is the same as that shown in FIG. 22(a) to 22(d). According to the embodiment, the rail guide 219 is engaged by the engagement parts 219c and 219d to reinforce the bent parts 210f and 210g.

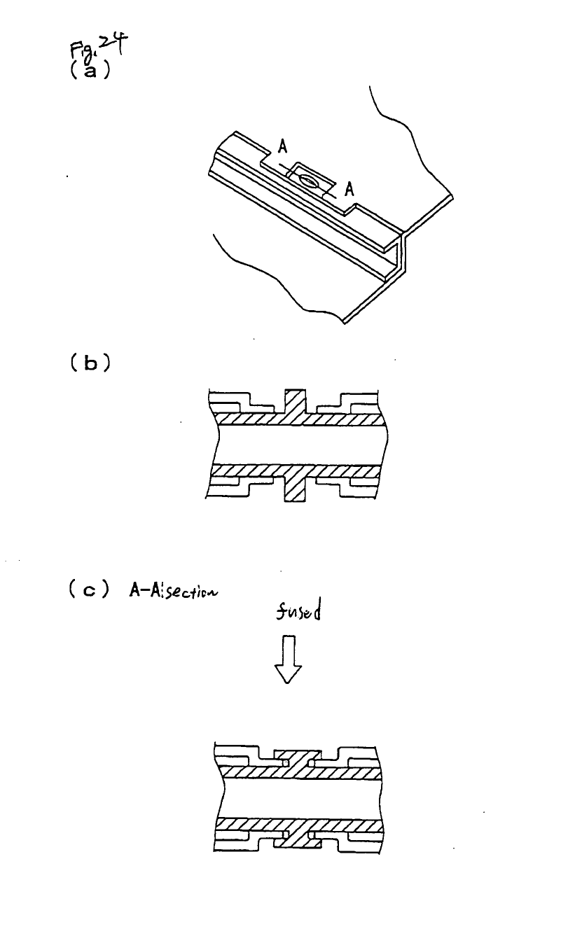

Note that as shown in FIGS. 24(a) to 24(c), the protrusions 219a and 219b may be protruded from the surfaces of the protrusion 220 and the bottom surface 210h rather than providing the engagement parts and the protruded parts may be fused by ultrasonic welding or hot welding to form engagement parts.

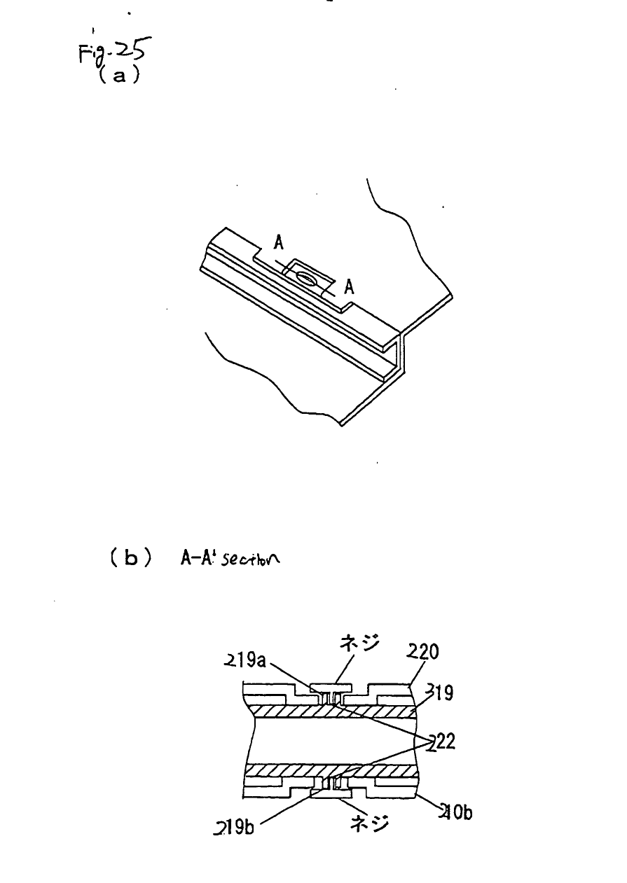

FIGS. 25(a) and 25(b) show another example of how the rail guide 219 is fixed to the lower cover 210b. The protrusions 219a and 219b of the rail guide 219 are engaged with the through holes 220a and 210n, and their tip ends are flat and have screw holes 222. The protrusions 219a and 220, and the protrusions 219b and the bottom surface 210h are fixed by screws. A recess or step may be provided at the protrusion 220 and the bottom surface 210h so that the screw heads do not protrude from the surfaces of the protrusion 220 and the bottom surface 210h similarly to the example shown in FIGS. 22(a) to 22(d). FIGS. 26(a) to 26(c) show another example of how the rail guide 219 is fixed to the lower cover 210b. The protrusions 219a and 219b have no engagement part and engage with the through holes 220a and 220n, respectively in order to position the rail guide 219. At least part of the contact part between the rail guide 219 and the lower cover 210b is provided with an adhesive 221 and thus the rail guide 219 is fixed to the lower cover 210b. In this way, the rail guide 219 can reinforce the lower cover 210b.

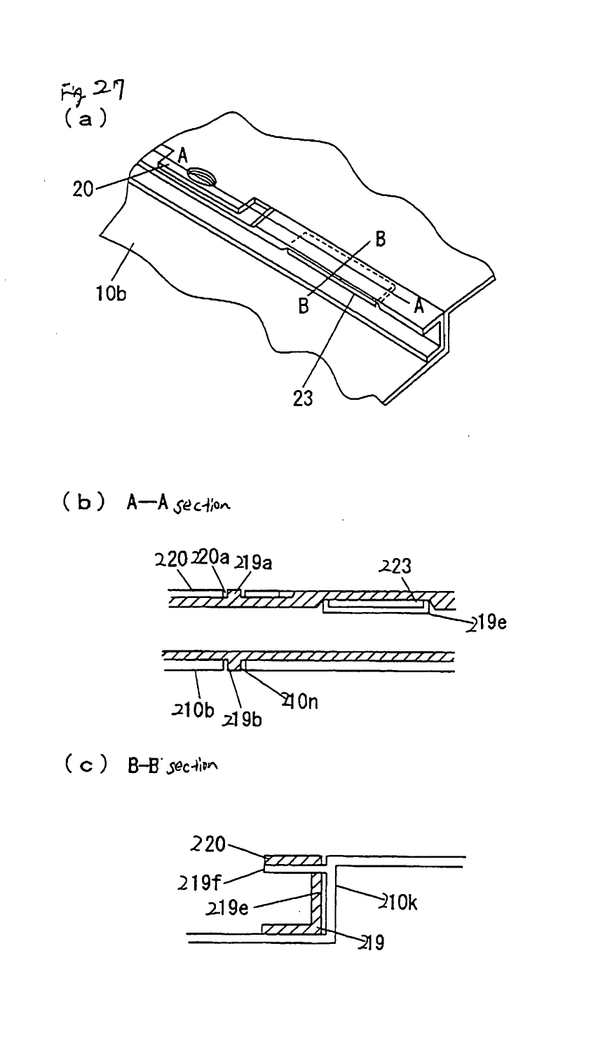

FIGS. 27(a) to 27(c) show another example of how the rail guide 219 is fixed to the lower cover 210b. The protrusions 219a and 219b provided at the rail guide 219 have no engagement part and engage with the through holes 220a and 220n, respectively, as a through hole 219e is in close contact with the side surface 210k. Meanwhile, another flat protrusion 223 substantially parallel to the bottom surface 210h is formed from the side surface 210k. The through hole 219e is provided at a part corresponding to the protrusion 223 at the surface of the rail guide 219 in contact with the side surface 210k. The protrusion 223 penetrates the through hole 219e and is in contact with the inner surface 219f of the rail guide 219. More specifically, one side of the rail guide 219 is held between the protrusions 220 and 223 from both sides in the thickness wise direction. Since the rail 209 slides, the part of the inner surface 219f of the rail guide 219 facing the protrusion 223 is thinned on the inner side than on the side of the rest of the part so that the protrusion 223 does not protrude from the inner surface 219f of the rail guide 219.

A plurality of such arrangements each having the rail guide 219 fixed to the lower cover 210b in the above-described manner are provided arrangements having the rail guides 219 fixed to the lower covers 210b in different manners may be provided.

What is claimed is:

1. An optical disk device, comprising:
a case, having first and second case members fixed with each other;
a driver, rotating a medium;
an optical pickup module, including optical elements; and
a circuit portion, forming a control portion;
wherein:
at least one of the first and second case members has a main surface and side surfaces provided at ends of the main surface;
an integral part is provided at a corner where a pair of the side surfaces in at least one of the first and second case members adjoin such that the integral part is continuously integrated with the at least one pair of side surfaces.

2. The optical disk device according to claim 1, wherein the integral part is formed by all parts of the corner.

3. The optical disk device according to claim 1, wherein the corner includes an unconnected part where a pair of side surfaces are not connected and an integral part where the pair of side surfaces are integrally connected.

4. The optical disk device according to claim 3, wherein the unconnected part and the integral part are provided in this order from the main surface side.

5. The optical disk device according to claim 3, wherein the integral part and the unconnected part are provided in this order from the main surface side.

6. The optical disk device according to claim 3, wherein a first unconnected part, the integral part, and a second unconnected part are provided in this order from the main surface side.

7. The optical disk device according to claim 1, wherein at least one of the first and second case members is formed by drawing.

8. The optical disk device according to claim 1, wherein the outer surface of the integral part has a C-shape or a curved shape.

9. The optical disk device according to claim 1,
wherein:
a tray is movably provided at the first case member, the first and second case members are each provided with a main surface and side surfaces provided at ends of the main surfaces, the tray is positioned between the main surfaces of the first and second case members, the side surfaces of the first and second case members oppose each other, and one or more first protrusions are provided at a part of the side surfaces of the second case member opposing the first case member.

10. The optical disk device according to claim 9, wherein:
the main surfaces of the first and second case members are rectangular, and a first protrusion is provided at each of three side surfaces of the first and second case members.

11. The optical disk device according to claim 1, wherein:
the average thickness of the second case member is from 0.4 to 0.83 when the average thickness of the first case member is 1.

12. The optical disk device according to claim 1, wherein the first and second case members are made of at least one of iron, an iron alloy, aluminum, an aluminum alloy, and a magnesium alloy.

13. The optical disk device according to claim 1, wherein the average thickness of the first case member is from 0.4 mm to 0.9 mm and the average thickness of the second case member is from 0.3 mm to 0.58 mm.

14. The optical disk device according to claim 9, wherein one or more second protrusions are provided at a part of the side surface of the first case member opposing the second case member.

15. The optical disk device according to claim 14, wherein the first and second protrusions are provided shifted from each other so as not to abut against each other.

16. The optical disk device according to claim 1, further comprising:
a tray at least carrying a driver and an optical pickup module, the tray being capable of protruding and withdrawing through an opening of the case including at least the first and second case members; and
a line connector, connected to the tray, wherein
a part of the inner wall of the case opposing at least one of the driver and the line connection means is provided with a recess.

17. The optical disk device according to claim 16, wherein
a recess is provided at a part opposing the line connector, and at least a part of the line connector is stored in the recess.

18. The optical disk device according to claim 17, wherein
the line connector is adhered to the inner wall of the case by adhesion means, and the adhered area of the line connector is equal to or larger than the area in which the recess is formed.

19. The optical disk device according to claim 18, wherein
a flexible printed circuit board is used as the line connection means, and
a tape like member having an adhesive layer on both faces is used as the adhesion means.

20. The optical disk device according to claim 16, wherein
a recess is provided in a location where the upper end of the driver passes when the tray is freely protruded and withdrawn.

21. The optical disk device according to claim 16, further comprising:
a first board, fixed to the case; and
a second board, fixed to the tray, wherein
the first and second boards are electrically connected by the line connection means.

22. The optical disk device according to claim 16, wherein:
the recess is formed by making the thickness of the case smaller than the other parts.

23. The optical disk device according to claim 1, wherein
the first case member includes a main bottom surface, a sub bottom surface substantially parallel to the main bottom surface and provided with a step near the second case member, a side surface connecting the main bottom surface and the sub bottom surface, a connection part connecting the main bottom surface and the second case member provided at an end of the sub bottom surface, and a planer protrusion extended from the vicinity of the intersecting line of the sub bottom surface and the side surface to the main bottom surface,
a reinforcement member is provided opposing the main surface, the side surface, and the protrusion, and
the reinforcement member and the protrusion are at least partly arranged so that the reinforcement member cramps the protrusion.

24. The optical disk device according to claim 23, wherein the reinforcement member also serves as holding means for holding the tray movably at the case.

25. The optical disk device according to claim 23, wherein the arrangement in which the reinforcement member cramps the protrusion includes an arrangement through engagement between an engagement part provided at the reinforcement member and a through hole provided at the protrusion.

26. The optical disk device according to claim 23, wherein the arrangement in which the reinforcement member cramps the protrusion includes an arrangement produced by deforming and expanding the tip end of the protrusion provided at the reinforcement member to cramp the protrusion.

27. The optical disk device according to claim 23, wherein the arrangement in which the reinforcement member cramps the protrusion includes an arrangement in which the reinforcement member has a through hole and the through hole is engaged with the protrusion.

28. The optical disk device according to claim 23, wherein the reinforcement member and the main bottom surface are engaged by an engagement structure.

29. The optical disk device according to claim 23, further comprising at least an arrangement in which the reinforcement member cramps the main bottom surface.

30. The optical disk device according to claim 29, wherein
the arrangement in which the reinforcement member cramps the main bottom surface includes an arrangement through engagement between an engagement part provided at the reinforcement member and a through hole provided at the main bottom surface.

31. The optical disk device according to claim 29, wherein
the arrangement in which the reinforcement member cramps the main bottom surface includes an arrangement produced by deforming and expanding the tip end of the protrusion provided at the reinforcement member to cramp the main bottom surface.

32. The optical disk device according to claim 29, wherein
the arrangement in which the reinforcement member cramps the main bottom surface includes an arrangement in which the reinforcement member has a through hole and the through hole engages with the main bottom surface.

33. The optical disk device according to claim 1, wherein
the first case member includes a main bottom surface, a sub bottom surface provided substantially parallel to the main bottom surface and having a step near the second case member, a side surface connecting the main bottom surface and the sub bottom surface, and a connection part connecting the main bottom surface and the second case member provided at an end of the sub bottom surface,
a reinforcement member is provided opposing the main bottom surface and the side surface, and
the reinforcement member includes a part adhered by an adhesive to at least one of the main bottom surface and the side surface.
